(19) United States
(12) Patent Application Publication
(10) Pub. No.: US 2009/0095081 A1
(43) Pub. Date: Apr. 16, 2009

(54) Semiconductor device

(75) Inventor: Goro Nakatani, Kyoto (JP)

Correspondence Address: RABIN & Berdo, PC, 1101 14TH STREET, NW, SUITE 500, WASHINGTON, DC, 20005, US

(73) Assignee: ROHM CO., LTD., Kyoto (JP)

(21) Appl. No.: 12/285,825

(22) Filed: Oct. 15, 2008

(30) Foreign Application Priority Data
Oct. 16, 2007 (JP) 2007-269148
Oct. 17, 2007 (JP) 2007-270434

(51) Int. Cl. G01P 15/125

(52) U.S. Cl. 73/514.32

(57) ABSTRACT

A semiconductor device according to the present invention includes a semiconductor substrate and an MEMS sensor provided on the semiconductor substrate. The MEMS sensor includes a vibratory first electrode and a plurality of second electrodes opposed to the first electrode at an interval.

### BACKGROUND OF THE INVENTION

1. Field of the Invention

The present invention relates to a semiconductor device including an MEMS (Micro Electro Mechanical Systems) sensor.

2. Description of Related Art

Application of an MEMS sensor to a portable telephone has recently been started, and hence the MEMS sensor attracts much attention. For example, an acceleration sensor for detecting the acceleration of an object is known as a typical MEMS sensor.

FIG. 9 is a sectional view schematically showing the structure of a conventional acceleration sensor.

The acceleration sensor shown in FIG. 9 includes a sensor body 101, a weight 102 held by the sensor body 101 and an annular base 103 supporting the sensor body 101.

The sensor body 101 integrally includes a membrane 104, an annular support portion 105 connected to a peripheral edge portion of a first surface (lower surface) of the membrane 104 and a weight fixing portion 106 connected to a central portion of the first surface of the membrane 104. A piezoresistor (not shown) is formed on a second surface (upper surface) of the membrane 104. An annular groove 107 having an isosceles trapezoidal section narrowed as approaching the membrane 104 isolates the support portion 105 and the weight fixing portion 106 from each other.

The weight 102 is in the form of a disc, for example. This weight 102 is arranged under the weight fixing portion 106, so that a central portion of the upper surface thereof is fixed to the weight fixing portion 106.

The base 103 is in the form of a ring having an inner diameter and an outer diameter generally identical to those of the lower surface of the support portion 105 of the sensor body 101. The support portion 105 is so placed on the base 103 that the base 103 supports the sensor body 101. The weight 102 is provided between the sensor body 101 and a surface on which the base 103 is set in a noncontact state with the base 103 and the support portion 105.

When the weight 102 is shaken in response to acceleration, the membrane 104 so vibrates that stress acts on the piezoresistor provided on the membrane 104. The resistivity of the piezoresistor changes in proportion to the stress acting thereon. When the change in the resistivity of each piezoresistor is extracted as a signal, therefore, the acceleration acting on the weight 102 can be obtained on the basis of this signal.

However, the acceleration sensor shown in FIG. 9 is employable only for detecting the acceleration, and cannot be employed for detecting physical quantities other than the acceleration. While a silicon microphone prepared by the MEMS technique is loaded on the recent portable telephone in place of an ECM (electret Condenser Microphone), for example, the acceleration sensor shown in FIG. 9 cannot be employed as a silicon microphone or used along with a silicon microphone.

### SUMMARY OF THE INVENTION

An object of the present invention is to provide a semiconductor device including an MEMS sensor usable as an acceleration sensor and a pressure sensor.

A semiconductor device according to one aspect of the present invention includes a semiconductor substrate and an MEMS sensor provided on the semiconductor substrate. The MEMS sensor includes a vibratory first electrode and a plurality of second electrodes placed opposite to the first electrode at an interval.

According to this structure, the MEMS sensor including the first electrode and the plurality of second electrodes is provided on the semiconductor substrate. The first electrode is provided in a vibratory manner, and the plurality of second electrodes are placed opposite to the first electrode at an interval.

Thus, the first electrode and each second electrode form a capacitor whose capacitance changes due to vibration of the first electrode. When acceleration is caused in the semiconductor device, the first electrode is distorted in response to the acceleration, and the interval between the first electrode and each second electrode is dispersed due to this distortion of the first electrode. Consequently, the capacitance of each capacitor formed by the first electrode and each second electrode is dispersed. Therefore, the acceleration caused in the semiconductor device can be obtained on the basis of the difference between the capacitances of the capacitors.

When the plurality of second electrodes are regarded as one electrode, this electrode and the first electrode, corresponding to a back plate and a diaphragm respectively, form a capacitor whose capacitance changes due to vibration of the first electrode (diaphragm). The capacitance of this capacitor is equal to the sum of the capacitances of the capacitors formed by the first electrode and the second electrodes respectively, whereby the magnitude of pressure (sound pressure, for example) input in the first electrode can be obtained on the basis of the sum of the capacitances of the capacitors.

Therefore, the MEMS sensor can be employed both as an acceleration sensor and a pressure sensor.

A semiconductor device according to another aspect of the present invention includes a semiconductor substrate and an MEMS sensor provided on the semiconductor substrate. The MEMS sensor includes a plurality of vibratory first electrodes and second electrodes of the same number as the first electrodes placed opposite to the first electrodes at an interval respectively.

According to this structure, the MEMS sensor including the plurality of first electrodes and the second electrodes of the same number as the first electrodes is provided on the semiconductor substrate. The first electrodes are provided in a vibratory manner respectively, and the second electrodes are placed opposite to the first electrodes at an interval respectively.

Thus, the first electrodes and the second electrodes opposed thereto form capacitors whose capacitances change due to vibration of the first electrodes. When acceleration is caused in the semiconductor device, each first electrodes vibrates, and the interval between each first electrodes and the second electrodes opposed thereto is dispersed. Consequently, the capacitances of the capacitors are dispersed. Therefore, the acceleration caused in the semiconductor device can be obtained on the basis of the difference between the capacitances of the capacitors.

When all the first electrodes are regarded as one electrode (hereinafter referred to as “first collective electrode” in this paragraph) and all the second electrodes are regarded as one electrode (hereinafter referred to as “second collective electrode” in this paragraph), the first collective electrode and the second collective electrode, corresponding to a diaphragm and a back plate respectively, form a capacitor whose capacitance changes due to vibration of the first collective electrode (diaphragm). The capacitance of this capacitor is equal to the sum of the capacitances of the capacitors formed by the first electrodes and the second electrodes respectively, whereby the magnitude of pressure (sound pressure, for example) input in the first collective electrode can be obtained on the basis of the sum of the capacitances of the capacitors.

Therefore, the MEMS sensor can be employed both as an acceleration sensor and a pressure sensor.

When the MEMS sensor is employed as an acceleration sensor, the semiconductor device according to each of the aspects of the present invention may include an acceleration detecting circuit detecting acceleration acting on the first electrode(s) on the basis of changes in the capacitances of the capacitors formed by the first electrode(s) and the second electrodes.

When the semiconductor device includes the acceleration detecting circuit, no semiconductor chip having a built-in acceleration detecting circuit is needed to be provided separately from the semiconductor device, whereby the structure of an apparatus loaded with the semiconductor device can be simplified.

When the MEMS sensor is employed as a pressure sensor, the semiconductor device according to each of the aspects of the present invention may include a pressure detecting circuit detecting pressure input in the first electrode(s) on the basis of changes in the capacitances of the capacitors formed by the first electrode(s) and the second electrodes.

When the semiconductor device includes the pressure detecting circuit, no semiconductor chip having a built-in pressure detecting circuit is needed to be provided separately from the semiconductor device, whereby the structure of an apparatus loaded with the semiconductor device can be simplified.

In the semiconductor device according to each of the aspects of the present invention, the following structures may be employed.

The second electrodes may be individually covered with insulating films respectively, and the insulating films may be in contact with a surface of the semiconductor substrate.

The semiconductor device may include a wire connected to the second electrodes, and the wire may be formed on the same layer as the second electrodes.

The semiconductor device may include a pad for connecting the wire with an external device, and the pad may be formed on the same layer as the first electrode(s).

The foregoing and other objects, features and effects of the present invention will become more apparent from the following detailed description of the embodiments with reference to the attached drawings.

### BRIEF DESCRIPTION OF THE DRAWINGS

FIG. 1 is a sectional view showing the structure of a semiconductor device according to a first embodiment of the present invention;

FIG. 2 is a schematic perspective view for illustrating capacitors provided on an MEMS sensor shown in FIG. 1;

FIG. 3 is a diagram showing a circuit structure for detecting acceleration and pressure with the MEMS sensor;

FIG. 4A is a schematic sectional view for illustrating a method of manufacturing the semiconductor device shown in FIG. 1;

FIG. 4B is schematic sectional view successively showing the step subsequent to the step shown in FIG. 4A;

FIG. 4C is schematic sectional view successively showing the step subsequent to the step shown in FIG. 4B;

FIG. 4D is schematic sectional view successively showing the step subsequent to the step shown in FIG. 4C;

FIG. 4E is schematic sectional view successively showing the step subsequent to the step shown in FIG. 4D;

FIG. 4F is schematic sectional view successively showing the step subsequent to the step shown in FIG. 4E;

FIG. 5 is a sectional view showing the structure of a semiconductor device according to a second embodiment of the present invention;

FIG. 6 is a plan view of a portion around an upper thin film shown in FIG. 5;

FIG. 7 is a schematic perspective view for illustrating capacitors provided on an MEMS sensor shown in FIG. 5;

FIG. 8A is a schematic sectional view for illustrating a method of manufacturing the semiconductor device shown in FIG. 5;

FIG. 8B is schematic sectional view successively showing the step subsequent to the step shown in FIG. 8A;

FIG. 8C is schematic sectional view successively showing the step subsequent to the step shown in FIG. 8B;

FIG. 8D is schematic sectional view successively showing the step subsequent to the step shown in FIG. 8C;

FIG. 8E is schematic sectional view successively showing the step subsequent to the step shown in FIG. 8D;

FIG. 8F is schematic sectional view successively showing the step subsequent to the step shown in FIG. 8E; and

FIG. 9 is a sectional view schematically showing the structure of a conventional acceleration sensor.

### DETAILED DESCRIPTION OF PREFERRED EMBODIMENTS

Embodiments of the present invention are now described in detail with reference to the attached drawings.

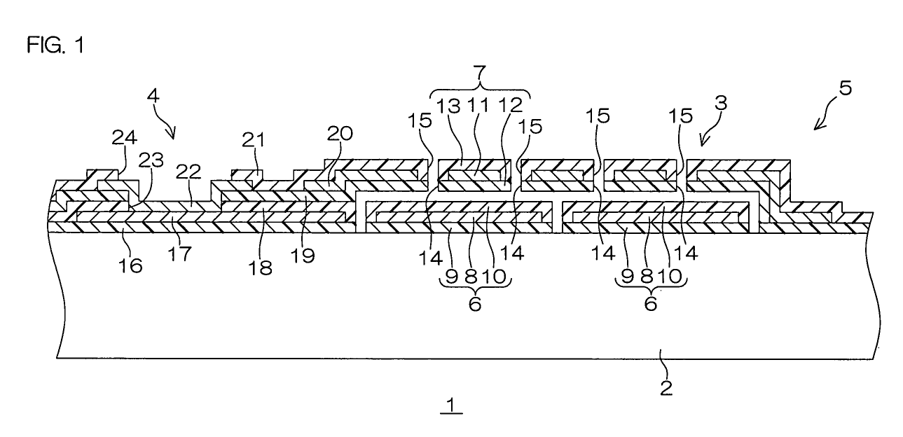

FIG. 1 is a sectional view showing the structure of a semiconductor device 1 according to a first embodiment of the present invention.

The semiconductor device 1 includes a semiconductor substrate (silicon substrate, for example) 2. An MEMS sensor 5 having a sensor portion 3 and a pad portion 4 is provided on the semiconductor substrate 2.

The sensor portion 3 includes four lower thin films 6 provided in contact with a surface of the semiconductor substrate 2 and an upper thin film 7 opposed to these lower thin films 6 at a prescribed interval.

The four lower thin films 6 are in the form of sectors in plan view respectively. The four lower thin films 6 are so arranged that arcuate peripheral edges thereof are located on the same circumference, for example.

Each lower tin film 6 is formed by covering a lower electrode 8 with a first lower insulating film 9 and a second lower insulating film 10. More specifically, the first lower insulating film 9 is made of SiN (silicon nitride). The first lower insulating film 9 is formed on the surface of the semiconductor substrate 2. The lower electrode 8 made of Al (aluminum) is formed on the lower insulating film 9. The second lower insulating film 10 is made of SiN. The second lower insulating film 10 is formed on the lower electrode 8 and the first lower insulating film 9. Thus, a lower surface of the lower electrode 8 is covered with the first lower insulating film 9, while an upper surface and side surfaces of the lower electrode 8 are covered with the second lower insulating film 10.

The upper thin film 7 is formed by covering an upper electrode 11 with a first upper insulating film 12 and a second upper insulating film 13. More specifically, the first upper insulating film 12 is made of SiN. The first upper insulating film 12 is formed above the lower thin films 6 at an interval. The upper electrode 11 made of Al is formed on the first upper insulating film 12. The second upper insulating film 13 is made of SiN. The second upper insulating film 13 is formed on the upper electrode 11 and the first upper insulating film 12. Thus, a lower surface of an upper electrode 11 is covered with the first upper insulating film 12, while an upper surface and side surfaces of the upper electrode 11 are covered with the second upper insulating film 13.

The upper electrode 11 is in the form of a mesh having a large number of pores. In the first upper insulating film 12, small pores 14 are formed on positions opposed to the respective pores of the upper electrode 11 penetratingly in the thickness direction. In the second upper insulating film 13, pores 15 identical in shape to the pores 14 in plan view are formed on positions opposed to the respective pores 14 penetratingly in the thickness direction.

The pad portion 4 includes a first insulating layer 16, first wires 17, a second insulating layer 18, a third insulating layer 19, a second wire 20, a fourth insulating layer 21 and pads 22.

The first insulating layer 16 is made of SiN. The first insulating layer 16 is formed on the surface of the semiconductor substrate 2 on the periphery of the sensor portion 3 (four lower thin films 6). The first insulating layer 16 has a connecting portion (not shown) connected to the first lower insulating film 9 of each lower thin film 6, and is integrated with the first lower insulating film 9 of each lower thin film 6.

The first wires 17 are made of Al. Four first wires 17 are provided in association with the lower electrodes 8 of the lower thin films 6. Each first wire 17 is formed on the first insulating layer 16 to extend on each connecting portion of the first insulating layer 16, and connected to the lower electrode 8 corresponding thereto.

The second insulating layer 18 is made of SiN. The second insulating layer 18 is formed on the first insulating layer 16, to cover an upper surface and side surfaces of the first wire 17. The second insulating layer 18 is connected to the second lower insulating film 10 of each lower thin film 6 on a portion covering each first wire 17 along with each connecting portion of the first insulating layer 16, to be integrated with the second lower insulating film 10 of each lower thin film 6.

The third insulating layer 19 is made of SiN. The third insulating layer 19 is formed on the second insulating layer 18. The third insulating layer 19 is continuous to the first upper insulating film 12 of the upper thin film 7 and is integrated with the first upper insulating film 12.

The second wire 20 is made of Al. The second wire 20 is formed on the third insulating layer 19, and electrically connected with the upper electrode 11 of the upper thin film 7.

The fourth insulating layer 21 is made of SiN. The fourth insulating layer 21 is formed on the third insulating layer 19, to cover an upper surface and side surfaces of the second wire 20. The fourth insulating layer 21 is continuous to the second upper insulating film 13 of the upper thin film 7 and is integrated with the second upper insulating film 13. Thus, the fourth insulating layer 21 vibratorily supports the upper tin film 7 with a cavity between the same and the lower thin film 6, along with the third insulating layer 19 continuous to the first upper insulating film 12.

The four pads 22 are made of Al. Four openings 23 (FIG. 1 illustrates only one opening 23) for partially exposing the first wires 17 respectively are formed in the second and third insulating layers 18 and 19 to continuously pass through these layers 18 and 19 in the thickness direction. Each pad 22 covers the corresponding first wire 17 in each opening 23, while a peripheral edge portion thereof extends onto the third insulating layer 19. Four openings 24 for exposing the respective pads 22 are formed in the fourth insulating layer 21. A peripheral edge portion of each pad 22 is covered with a portion of the fourth insulating layer 21 located around each opening 24. A wire for extracting a current flowing in each first wire 17 is connected to each pad 22.

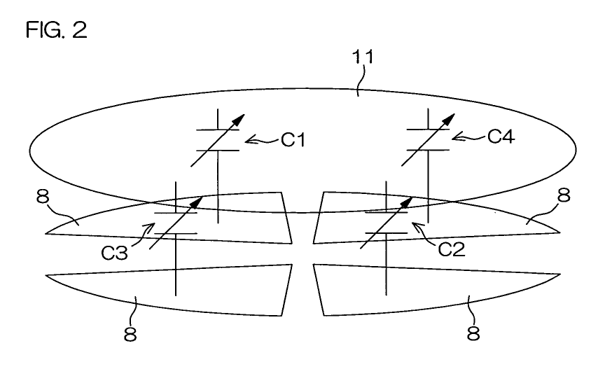

FIG. 2 is a schematic perspective view for illustrating capacitors provided on the MEMS sensor.

As hereinabove described, the MEMS sensor 5 includes the vibratory upper tin film 7 and the four lower thin films 6 opposed to the upper thin film 7 from below at the prescribed interval. Each lower thin film 6 includes the lower electrode 8, and the upper tin film 7 includes the upper electrode 11.

Thus, the lower electrodes 8 and the upper electrode 11 form capacitors C1, C2, C3 and C4 whose capacitances change due to vibration of the upper electrode 11 (upper thin film 7) respectively. When acceleration is caused in the semiconductor device 1, the upper electrode 11 is distorted in response to this acceleration, and the interval between the lower electrodes 8 (lower thin films 6) and the upper electrode 11 (upper thin film 7) is dispersed due to this distortion of the upper electrode 11. Consequently, the capacitances of the capacitors C1, C2, C3 and C4 formed by the lower electrodes 8 and the upper electrode 11 are dispersed. Therefore, the acceleration caused in the semiconductor device 1 can be obtained on the basis of the difference between the capacitances of the capacitors C1, C2, C3 and C4.

When the four lower electrodes 8 are regarded as one electrode, the electrode consisting of the four lower electrodes 8 and the upper electrode 11, corresponding to a back plate and a diaphragm respectively, form one capacitor whose capacitance changes due to vibration of the upper electrode 11 (diaphragm). The capacitance of this capacitor is equal to the sum of the capacitances of the capacitors C1, C2, C3 and C4 formed by the lower electrodes 8 and the upper electrode 11, whereby the magnitude of pressure (sound pressure, for example) input in the upper thin film 7 (upper electrode 11) can be obtained on the basis of the sum of the capacitances of the capacitors C1, C2, C3 and C4.

Therefore, the MEMS sensor 5 can be employed both as an acceleration sensor and a pressure sensor.

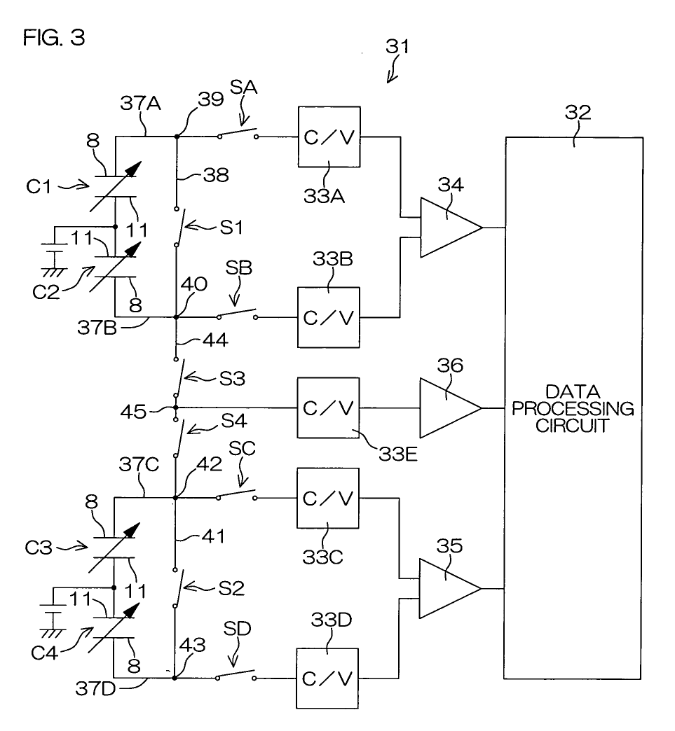

FIG. 3 is a diagram showing a circuit structure for detecting acceleration and pressure with the MEMS sensor.

The semiconductor device 1 includes an acceleration/pressure detecting circuit 31 and a data processing circuit 32 processing a signal received from the acceleration/pressure detecting circuit 31 and outputting a signal indicating acceleration and a pressure value. The acceleration/pressure detecting circuit 31 and the data processing circuit 32 are constituted of elements built into the semiconductor substrate 2, wires formed on the semiconductor substrate 2 and the like, and integrated into a chip along with the MEMS sensor 5.

The acceleration/pressure detecting circuit 31 includes five C/V conversion circuits 33A, 33B, 33C, 33D and 33E, two differential amplifiers 34 and 35 and one gain amplifier 36.

The input ends of the four C/V conversion circuits 33A, 33B, 33C and 33D are connected to the lower electrodes 8 of the capacitors C1, C2, C3 and C4 through wires 37A, 37B, 37C and 37D respectively. The wires 37A, 37B, 37C and 37D include the first wires 17 (see FIG. 1) respectively.

As shown in FIG. 2, the lower electrodes 8 of the capacitors C1 and C2 are opposed to each other through the center of the upper electrode 11 in plan view, while the lower electrodes 8 of the capacitors C3 and C4 are also opposed to each other through the center of the upper electrode 11 in plan view. The opposed direction of the lower electrodes 8 of the capacitors C1 and C2 is hereinafter referred to as “direction X”, and the opposed direction of the lower electrodes 8 of the capacitors C3 and C4 is referred to as “direction Y” orthogonal to the direction X. A direction orthogonal to the directions X and Y is referred to as “direction Z”.

The output ends of the two C/V conversion circuits 33A and 33B are connected to the input end of the differential amplifier 34. The output ends of the remaining two C/V conversion circuits 33C and 33D are connected to the input end of the other differential amplifier 35. The output ends of the differential amplifiers 34 and 35 are connected to the data processing circuit 32.

An end of a connecting wire 38 is connected to an intermediate portion of the wire 37A. The other end of the connecting wire 38 is connected to an intermediate portion of the wire 37B. In the wire 37A, a switch SA is interposed between a node 39 of the connecting wire 38 and the C/V conversion circuit 33A. In the wire 37B, a switch SB is interposed between a node 40 of the connecting wire 38 and the C/V conversion circuit 33B. A switch S1 is interposed on an intermediate portion of the connecting wire 38.

An end of a connecting wire 41 is connected to an intermediate portion of the wire 37C. The other end of the connecting wire 41 is connected to an intermediate portion of the wire 37D. In the wire 37C, a switch SC is interposed between a node 42 of the connecting wire 41 and the C/V conversion circuit 33C. In the wire 37D, a switch SD is interposed between a node 43 of the connecting wire 41 and the C/V conversion circuit 33D. A switch S2 is interposed on an intermediate portion of the connecting wire 41.

An end of a connecting wire 44 is connected to the node 40. The other end of the connecting wire 44 is connected to the node 42. The input end of the C/V conversion circuit 33E is connected to an intermediate portion of the connecting wire 44. The output end of the C/V conversion circuit 33E is connected to the input end of the gain amplifier 36. The output end of the gain amplifier 36 is connected to the data processing circuit 32. In the connecting wire 44, switches S3 and S4 are interposed between the node 40 and a node 45 of the C/V conversion circuit 33E and between the nodes 42 and 45 respectively.

A prescribed voltage (11 V, for example) is applied to the upper electrode 11.

In order to detect acceleration in the direction X, the switches SA and SB are turned on, while the switches S1, S2, S3 and S4 are turned off. When acceleration in the direction X is caused in the semiconductor device 1 and the upper electrode 11 is distorted in response to this acceleration in the direction X, the capacitances of the capacitors C1 and C2 change due to the distortion of the upper electrode 11 respectively. Following the change in the capacitance of the capacitor C1, a current responsive to this change of the capacitance flows in the wire 37A connected to the lower electrode 8 of the capacitor C1. The current flowing in the wire 37A is input in the C/V conversion circuit 33A. The C/V conversion circuit 33A forms a voltage signal responsive to the input current Following the change in the capacitance of the capacitor C2, on the other hand, a current responsive to this change of the capacitance flows in the wire 37B connected to the lower electrode 8 of the capacitor C2. The current flowing in the wire 37B is input in the C/V conversion circuit 33B. The C/V conversion circuit 33B forms a voltage signal responsive to the input current. The voltage signals formed in the C/V conversion circuits 33A and 33B respectively are input in the differential amplifier 34. The differential amplifier 34 multiplies the difference between the voltage signals formed in the C/V conversion circuits 33A and 33B respectively by a proper gain, thereby forming a differential amplification signal. The formed differential amplification signal corresponds to the difference between the changes in the capacitances of the capacitors C1 and C2 resulting from the acceleration in the direction X. Therefore, the data processing circuit 32 can obtain (the direction and the magnitude of) the acceleration in the direction X on the basis of the differential amplification signal received from the differential amplifier 34.

In order to detect acceleration in the direction Y, the switches SC and SD are turned on, while the switches S1, S2, S3 and S4 are turned off. When acceleration in the direction Y is caused in the semiconductor device 1 and the upper electrode 11 is distorted due to the acceleration in the direction Y, the capacitances of the capacitors C3 and C4 change due to the distortion of the upper electrode 11 respectively. Following the change in the capacitance of the capacitor C3, a current responsive to the change of the capacitance flows in the wire 37C connected to the lower electrode 8 of the capacitor C3. The current flowing in the wire 37C is input in the C/V conversion circuit 33C. The C/V conversion circuit 33C forms a voltage signal responsive to the input current. Following the change in the capacitance of the capacitor C4, on the other hand, a current responsive to the change of the capacitance flows in the wire 37D connected to the lower electrode 8 of the capacitor C4. The current flowing in the wire 37D is input in the C/V conversion circuit 33D. The C/V conversion circuit 33D forms a voltage signal responsive to the input current. The voltage signals formed in the C/V conversion circuits 33C and 33D are input in the differential amplifier 35. The differential amplifier 35 multiplies the difference between the voltage signals formed in the C/V conversion circuits 33C and 33D respectively by a proper gain, thereby forming a differential amplification signal. The formed differential amplification signal corresponds to the difference between the changes in the capacitances of the capacitors C3 and C4 resulting from the acceleration in the direction Y. Therefore, the data processing circuit 32 can obtain (the direction and the magnitude of) the acceleration in the direction Y on the basis of the differential amplification signal received from the differential amplifier 35.

In order to detect acceleration in the direction Z, the switches SA, SB, SC and SD are turned off, while the switches S1, S2, S3 and S4 are turned on. When the upper electrode 11 is distorted in response to acceleration in the direction Z, the capacitances of the capacitors C1, C2, C3 and C4 change due to the distortion of the upper electrode 11 respectively. Following this, currents responsive to the changes in the capacitances of the capacitors C1, C2, C3 and C4 flow in the wires 37A, 37B, 37C and 37D respectively. The switches SA and SB are turned off while the switches S and S3 are turned on, whereby the current flowing in the wire 37A passes through the connecting wire 38 and joins the current flowing in the wire 37B. After this joining, the currents flowing in the wires 37A and 37B are input in the C/V conversion circuit 33E through the connecting wire 44. Further, the switches SC and SD are turned off while the switches S2 and S4 are turned on, whereby the current flowing in the wire 37D passes through the connecting wire 41 and joins the current flowing in the wire 37C. After this joining, the currents flowing in the wires 37C and 37D are input in the C/V conversion circuit 33E through the connecting wire 44. In other words, the currents flowing in the wires 37A, 37B, 37C and 37D are jointly input in the C/V conversion circuit 33E. The C/V conversion circuit 33E forms a voltage signal responsive to the input current. The voltage signal formed in the C/V conversion circuit 33E is input in the gain amplifier 36. The gain amplifier 36 multiplies the voltage signal formed in the C/V conversion circuit 33E by a proper gain, thereby forming an amplification signal. The formed amplification signal corresponds to the sum of the changes in the capacitances of the capacitors C1, C2, C3 and C4 resulting from the acceleration in the direction Z. Therefore, the data processing circuit 32 can obtain (the direction and the magnitude of) the acceleration in the direction Z on the basis of the amplification signal received from the gain amplifier 36.

In order to detect acceleration, the state of turning on the switches SA and SB while turning off the switches S1, S2, S3 and S4, the state of turning on the switches SC and SD while turning off the switches S1, S2, S3 and S4 and the state of turning off the switches SA, SB, SC and SD while turning on the switches S1, S2, S3 and S4 are so switched at proper timings that the data processing circuit 32 can successively obtain the acceleration in the direction X, that in the direction Y and that in the direction Z.

In order to detect pressure, on the other hand, the switches SA, SB, SC and SD are turned off, while the switches S1, S2, S3 ad S4 are turned on. When pressure is input in the upper thin film 7 (see FIG. 1) and the upper electrode 11 is distorted in response to this pressure, the capacitances of the capacitors C1, C2, C3 and C4 change due to the distortion of the upper electrode 11 respectively. Following this, currents responsive to the changes in the capacitances of the capacitors C1, C2, C3 and C4 flow in the wires 37A, 37B, 37C and 37D respectively. The switches SA, SB, SC and SD are turned off while the switches S1, S2, S3 and S4 are turned on, whereby the currents flowing in the wires 37A, 37B, 37C and 37D are jointly input in the C/V conversion circuit 33E, similarly to the case of the detection of the acceleration in the direction Z. The C/V conversion circuit 33E forms a voltage signal responsive to the input current. The voltage signal formed in the C/V conversion circuit 33E is input in the gain amplifier 36. The gain amplifier 36 multiplies the voltage signal formed in the C/V conversion circuit 33E by a proper gain, thereby forming an amplification signal. The formed amplification signal corresponds to the sum of the changes in the capacitances of the capacitors C1, C2, C3 and C4 resulting from the pressure input in the upper thin film 7. Therefore, the data processing circuit 32 can obtain the magnitude of the pressure (sound pressure, for example) input in the upper thin film 7 on the basis of the amplification signal received from the gain amplifier 36.

The semiconductor device 1 includes the acceleration/pressure detecting circuit 31 and the data processing circuit 32 and no semiconductor chip having built-in such circuits is needed to be provided separately from the semiconductor device 1, whereby the structure of an apparatus loaded with the semiconductor device 1 can be simplified.

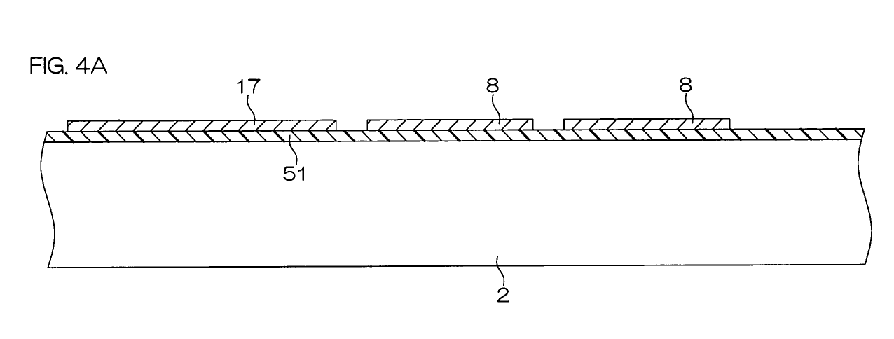

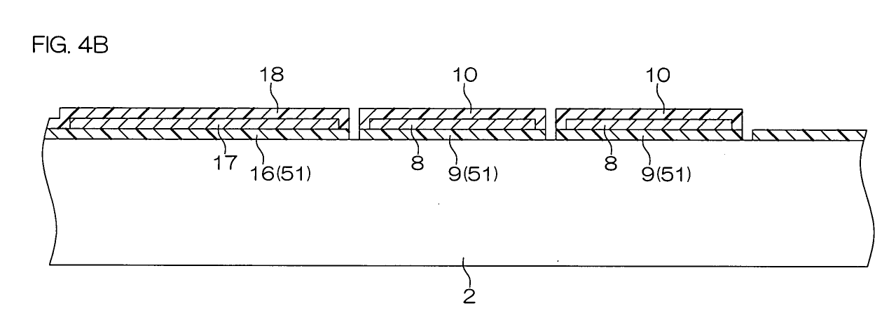

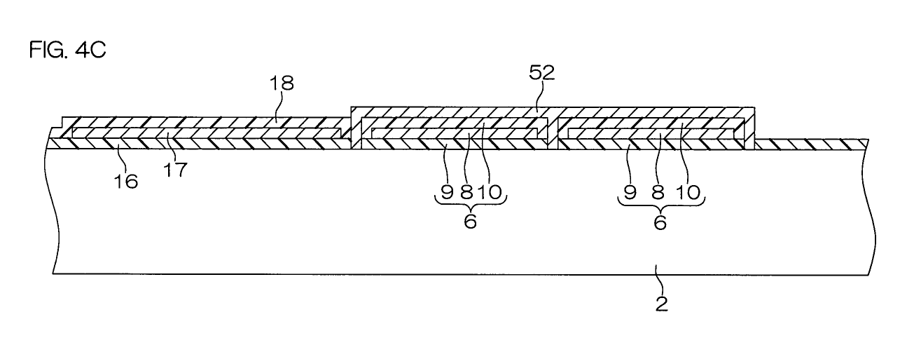

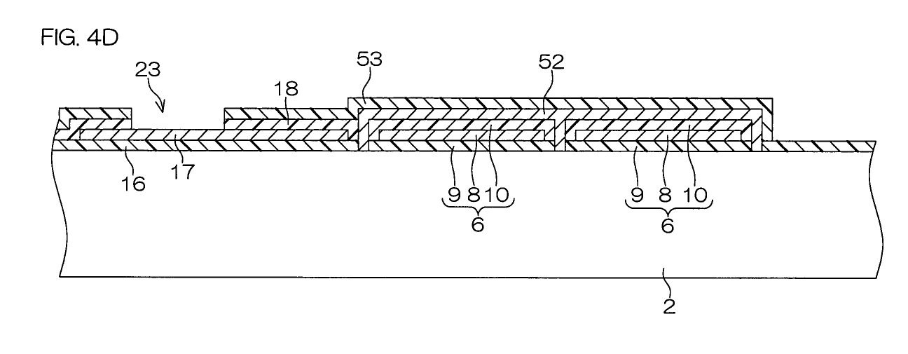

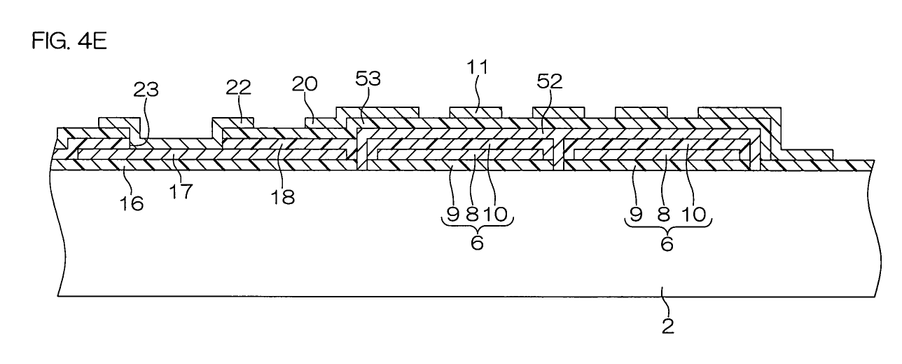

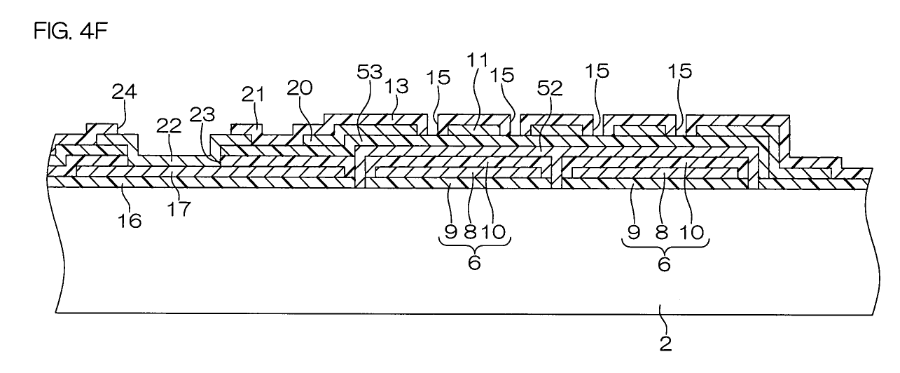

FIGS. 4A to 4F are schematic sectional views successively showing the steps of manufacturing the MEMS sensor.

First, a first SiN layer 51 is formed on the surface of the semiconductor substrate 2 by P-CVD (Plasma Chemical Vapor Deposition), as shown in FIG. 4A. Thereafter an Al film is formed on the first SiN layer 51 by sputtering. Then, the Al film is patterned by well-known photolithography and etching. Thus, the lower electrodes 8 and each first wire 17 are formed on the first SiN layer 51.

Then, a second SiN layer is formed on the overall region of the first SiN layer 51 including the lower electrodes 8 and the first wire 17 by P-CVD. Then, the first SiN layer 51 and the second SiN layer are patterned by well-known photolithography and etching, as shown in FIG. 4B. Thus, the first SiN layer 51 forms the first lower insulating films 9 and the first insulating layer 16, while the second SiN layer forms the second lower insulating films 10 and the second insulating layer 18. Thus, the four lower thin films 6 each having the structure formed by holding the lower electrode 8 between the first and second lower insulating films 9 and 10 are obtained. At this point of time, the second insulating layer 18 is not yet provided with an opening for partially exposing each first wire 17.

Then, SiO₂ (silicon oxide) is deposited on the overall region of the semiconductor substrate 2 (including the second lower insulating films 10 and the second insulating layer 18) by P-CVD, and thereafter removed from the second insulating layer 18 by well-known photolithography and etching. Thus, a first sacrificial layer 52 made of SiO₂ is formed on the second lower insulating films 10 and portions of the semiconductor substrate 2 exposed through the spaces between the second lower insulating films 10 and the second insulating layer 18, as shown in FIG. 4C.

After the formation of the first sacrificial layer 52, SiN is deposited on the overall region of the semiconductor substrate 2 by P-CVD, and the deposition layer of SiN is patterned by well-known photolithography and etching. Thus, a third SiN layer 53 is formed, as shown in FIG. 4D. When the deposition layer of SiN is etched, the second insulating layer 18 is so partially etched that the opening 23 is formed in the second insulating layer 18 and the third SiN layer 53 to continuously pass through these layers 18 and 53 in the thickness direction.

Then, an Al film is formed on the overall region of the semiconductor substrate 2 by sputtering. Then, this Al film is patterned by well-known photolithography and etching. Thus, the upper electrode 11, the second wire 20 and each pad 22 are formed on the third SiN layer 53, as shown in FIG. 4E.

Thereafter a fourth SiN layer is formed on the overall region of the semiconductor substrate 2 by P-CVD. Then, the pores 15 and each opening 24 are formed in the fourth SiN layer by well-known photolithography and etching, as shown in FIG. 4F. Thus, the fourth SiN layer forms the second upper insulating film 13 and the fourth insulating layer 21. The third SiN layer 53 is etched through the large number of pores 15, whereby the large number of pores 14 are formed in the third SiN layer 53, as shown in FIG. 1. Thus, the third SiN layer 53 forms the first upper insulating film 12 and the third insulating layer 19, and the upper thin film 7 is obtained in the structure formed by holding the upper electrode 11 between the first upper insulating film 12 and the second upper insulating film 13.

Then, an etching solution (hydrofluoric acid, for example) is supplied from the pores 14 and 15, thereby etching the first sacrificial layer 52. Thus, a cavity is formed between the lower thin films 6 and the upper thin film 7 so that the upper thin film 7 is vibratory in the direction opposed to the lower thin films 6, and the semiconductor device 1 is obtained.

While the first lower insulating films 9, the second lower insulating films 10, the first upper insulating film 12, the second upper insulating film 13, the first insulating layer 16, the second insulating layer 18, the third insulating layer 19 and the fourth insulating layer 21 are made of SiN, the material therefor may be replaced with SiO₂ or a Low-k film material having a lower dielectric constant than SiO₂, so far as the same is an insulating material.

While the first sacrificial layer 52 is made of SiO₂, the material for the first sacrificial layer 52 is not restricted to SiO₂, but another material may be employed so far as the same has an etching selection ratio with the material for the first lower insulating films 9, the second lower insulating films 10, the first upper insulating film 12, the second upper insulating film 13, the first insulating layer 16, the second insulating layer 18, the third insulating layer 19 and the fourth insulating layer 21. If the first lower insulating films 9, the second lower insulating films 10, the first upper insulating film 12, the second upper insulating film 13, the first insulating layer 16, the second insulating layer 18, the third insulating layer 19 and the fourth insulating layer 21 are made of SiO₂, for example, SiN may be employed as the material for the first sacrificial layer 52.

Further, the material for the lower electrodes 8 and the upper electrode 11 is not restricted to Al, but another metal such as Au may be employed.

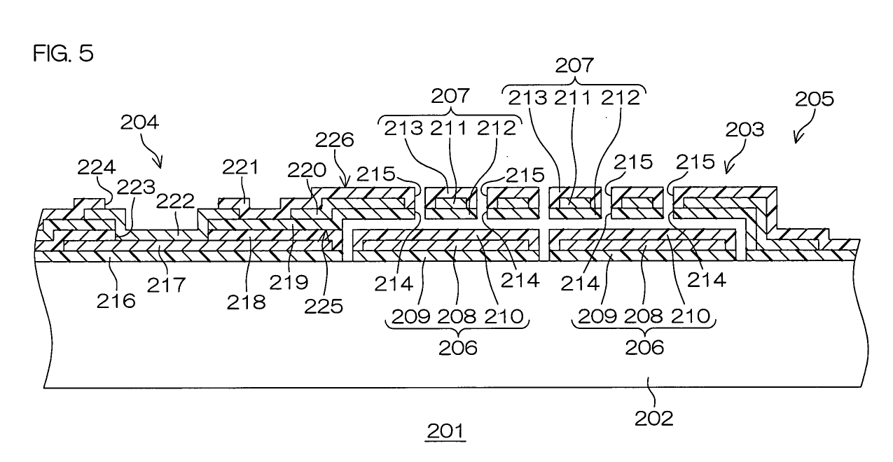

FIG. 5 is a sectional view showing the structure of a semiconductor device according to a second embodiment of the present invention.

The semiconductor device 201 includes a semiconductor substrate (silicon substrate, for example) 202. An MEMS sensor 205 having a sensor portion 203 and a pad portion 204 is provided on the semiconductor substrate 202.

The sensor portion 203 includes four lower thin films 206 provided in contact with a surface of the semiconductor substrate 202 and four upper thin films 207 opposed to the lower thin films 206 at a prescribed interval respectively.

The four lower thin films 206 are in the form of sectors in plan view respectively, and so arranged that arcuate peripheral edges thereof are located on the same circumference, for example.

Each lower thin film 206 has a structure formed by covering a lower electrode 208 with a first lower insulating film 209 and a second lower insulating film 210. More specifically, the first lower insulating film 209 is made of SiN (silicon nitride). The first lower insulating film 209 is formed on the surface of the semiconductor substrate 202. The lower electrode 208 made of Al (aluminum) is formed on the first lower insulating film 209. The second lower insulating film 210 is made of SiN. The second lower insulating film 210 is formed on the lower electrode 208 and the first lower insulating film 209. Thus, a lower surface of the lower electrode 208 is covered with the first lower insulating film 209, while an upper surface and side surfaces of the lower electrode 208 are covered with the second lower insulating film 210.

The four upper thin films 207 are formed generally identical to the lower thin films 206 respectively (in the form of sectors) in plan view.

Each upper thin film 207 has a structure formed by covering an upper electrode 211 with a first upper insulating film 212 and a second upper insulating film 213. More specifically, the first upper insulating film 212 is made of SiN. The first upper insulating film 212 is formed above the corresponding lower thin film 206 at an interval therefrom. The upper electrode 211 made of Al is formed on the first upper insulating film 212. The second upper insulating film 213 is made of SiN. The second upper insulating film 213 is formed on the upper electrode 211 and the first upper insulating film 212. Thus, a lower surface of the upper electrode 211 is covered with the first upper insulating film 212, while an upper surface and side surfaces of the upper electrode 211 are covered with the second upper insulating film 213.

The upper electrode 211 is in the form of a mesh having a large number of pores. In the first upper insulating film 212, small pores 214 are formed on positions opposed to the respective pores of the upper electrode 211 penetratingly in the thickness direction. In the second upper insulating film 213, pores 215 identical in shape to the pores 214 in plan view are formed on positions opposed to the respective pores 214 penetratingly in the thickness direction.

The pad portion 204 includes a first insulating layer 216, first wires 217, a second insulating layer 218, a third insulating layer 219, a second wire 220, a fourth insulating layer 221 and pads 222.

The first insulating layer 216 is made of SiN. The first insulating layer 216 is formed on the surface of the semiconductor substrate 202 on the periphery of the sensor portion 203 (four lower thin films 206). The first insulating layer 216 has a connecting portion (not shown) connected to the first lower insulating film 209 of each lower thin film 206, and is integrated with the first lower insulating film 209 of each lower thin film 206.

The first wires 217 are made of Al. Four first wires 217 are provided in association with the lower electrodes 208 of the lower thin films 206. Each first wire 217 is formed on the first insulating layer 216 to extend on each connecting portion of the first insulating layer 216, and connected to the lower electrode 208 corresponding thereto.

The second insulating layer 218 is made of SiN. The second insulating layer 218 is formed on the first insulating layer 216, to cover the upper surface and the side surfaces of the first wire 217. The second insulating layer 218 is connected to the second lower insulating film 210 of each lower thin film 206 on a portion covering each first wire 217 along with each connecting portion of the first insulating layer 216, to be integrated with the second lower insulating film 210 of each lower thin film 206.

The third insulating layer 219 is made of SiN. The third insulating layer 219 is formed on the second insulating layer 218. The third insulating layer 219 has a connecting portion 225 connected to the first upper insulating film 212 of each upper thin film 207, and is integrated with the first upper insulating film 212 of each upper thin film 207.

The second wire 220 is made of Al. The second wire 220 is formed on the third insulating layer 219 to extend on each connecting portion 225 of the third insulating layer 219, and electrically connected with the upper electrode 211 of each upper thin film 207.

The fourth insulating layer 221 is made of SiN. The fourth insulating layer 221 is formed on the third insulating layer 219, to cover the upper surface and the side surfaces of the second wire 220. In the fourth insulating layer 221, a portion 226 covering the second wire 220 along with each connecting portion 225 of the third insulating layer 216 is continuous to the second upper insulating film 213 of each upper thin film 207. Thus, the fourth insulating layer 221 is integrated with the second upper insulating film 213.

The four pads 222 are made of Al. Four openings 223 (FIG. 5 illustrates only one opening 223) for partially exposing the first wires 217 respectively are formed in the second and third insulating layers 218 and 219 to continuously pass through these layers 218 and 219 in the thickness direction. Each pad 222 covers the corresponding first wire 217 in each opening 223, while a peripheral edge portion thereof extends onto the third insulating layer 219. Four openings 224 for exposing the respective pads 222 are formed in the fourth insulating layer 221. A peripheral edge portion of each pad 222 is covered with a portion of the fourth insulating layer 221 located around each opening 224. A wire for extracting a current flowing in each first wire 217 is connected to each pad 222.

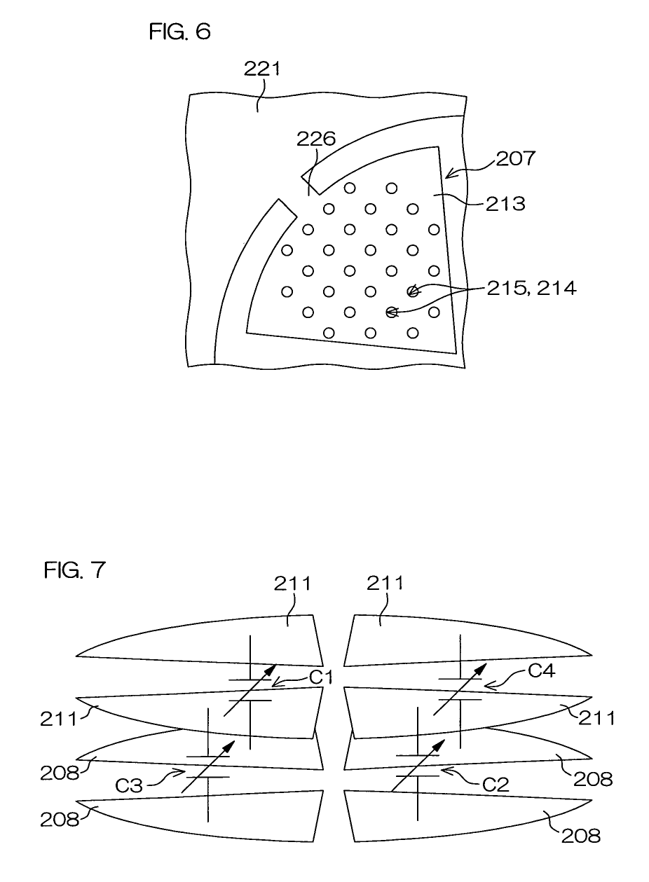

FIG. 6 is a plan view of a portion around each upper thin film.

The upper thin film 207 is vibratorily cantilever-supported by the connecting portion 225 (see FIG. 5) of the third insulating layer 219, the second wire 220 formed on the connecting portion 225 and the portion 226 of the fourth insulating layer 219 covering the second wire 220 along with the connecting portion 225, while defining a cavity between the same and the lower thin film 206. Therefore, each upper thin film 207 vibrates due to small acceleration or pressure.

FIG. 7 is a schematic perspective view for illustrating capacitors provided on the MEMS sensor.

As hereinabove described, the MEMS sensor 205 includes the four vibratory upper thin films 207 and the four lower thin films 206 opposed to the respective upper thin films 207 from below at the prescribed interval. Each lower thin film 206 includes the lower electrode 208, while each upper thin film 207 includes the upper electrode 211.

Thus, the four pairs of lower electrodes 208 and upper electrodes 211 form capacitors C1, C2, C3 and C4 whose capacitances change due to vibration of the upper electrodes 211 (upper thin films 207) respectively. When acceleration is caused in the semiconductor device 201, each upper electrode 211 vibrates, and the interval between each lower electrode 208 (lower thin film 206) and the upper electrode 211 (upper thin film 207) opposed thereto is dispersed. Consequently, the capacitances of the capacitors C1, C2, C3 and C4 are dispersed. Therefore, the acceleration caused in the semiconductor device 201 can be obtained on the basis of the difference between the capacitances of the capacitors C1, C2, C3 and C4.

When the four lower electrodes 208 are regarded as one electrode (hereinafter referred to as “lower collective electrode” in this paragraph) and the four upper electrodes 211 are regarded as one electrode (hereinafter referred to as “upper collective electrode” in this paragraph), the lower collective electrode and the upper collective electrode, corresponding to a back plate and a diaphragm respectively, form a capacitor whose capacitance changes due to vibration of the upper collective electrode (diaphragm). The capacitance of this capacitor is equal to the sum of the capacitances of the capacitors C1, C2, C3 and C4, whereby the magnitude of pressure (sound pressure, for example) input in the upper thin films 207 (upper electrodes 211) can be obtained on the basis of the sum of the capacitances of the capacitors C1, C2, C3 and C4.

Therefore, the MEMS sensor 205 can be employed both as an acceleration sensor and a pressure sensor.

The circuits shown in FIG. 3 can be employed as those for detecting acceleration and pressure with the MEMS sensor 205. When the semiconductor device 201 includes the circuits (the acceleration/pressure detecting circuit 31 and the data processing circuit 32) shown in FIG. 3, no semiconductor chip having such circuits is needed to be provided separately from the semiconductor device 201, whereby the structure of an apparatus loaded with the semiconductor device 201 can be simplified.

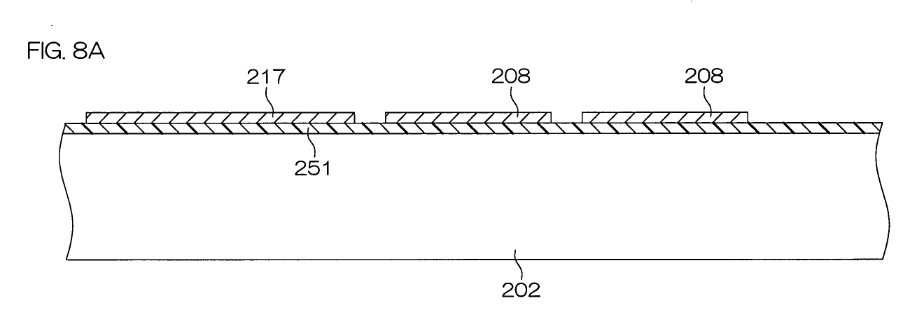

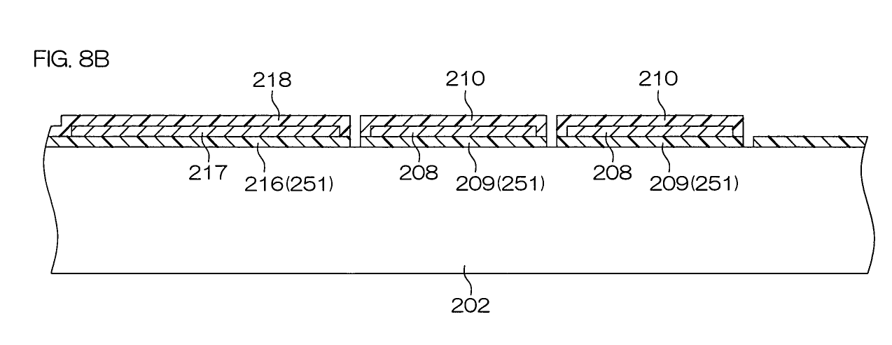

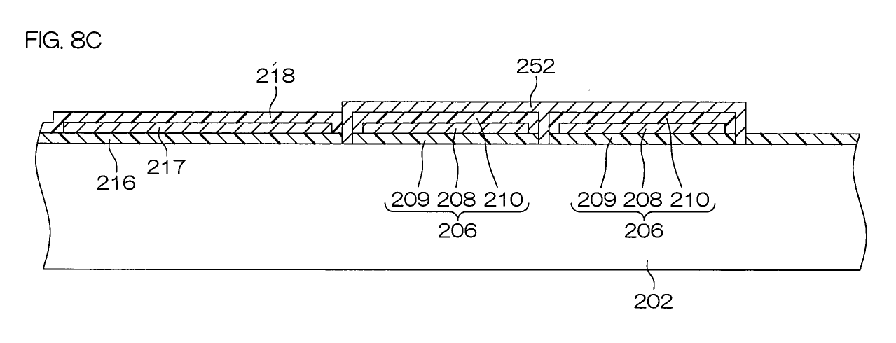

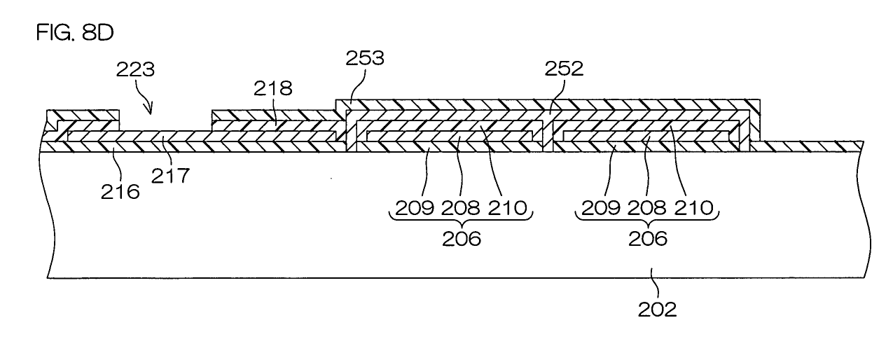

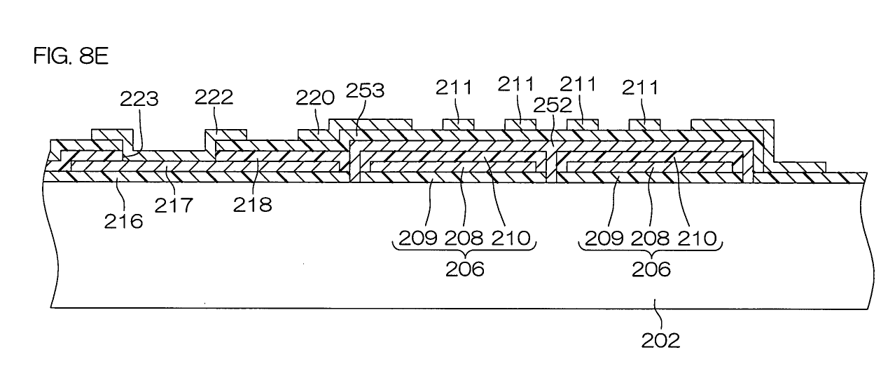

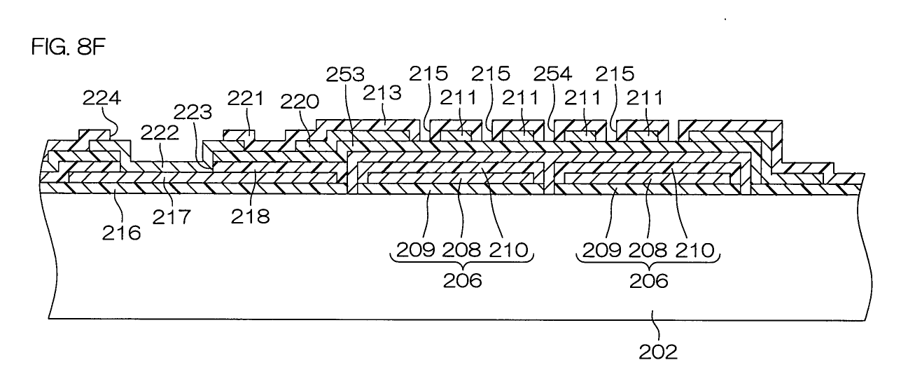

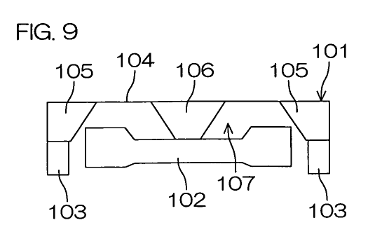

FIGS. 8A to 8F are schematic sectional views showing the steps of manufacturing the MEMS sensor.

First, a first SiN layer 251 is formed on the surface of the semiconductor substrate 202 by P-CVD (Plasma Chemical Vapor Deposition), as shown in FIG. 8A. Thereafter an Al film is formed on the first SiN layer 251 by sputtering. Then, the Al film is patterned by well-known photolithography and etching. Thus, the lower electrodes 208 and each first wire 217 are formed on the first SiN layer 251.

Then, a second SiN layer is formed on the overall region of the first SiN layer 251 including the lower electrodes 208 and the first wire 217 by P-CVD. Then, the first SiN layer 251 and the second SiN layer are patterned by well-known photolithography and etching, as shown in FIG. 8B. Thus, the first SiN layer 251 forms the first lower insulating films 209 and the first insulating layer 216, and the second SiN layer forms the four second lower insulating films 210 and the second insulating layer 218. Thus, the four lower thin films 206 each having the structure formed by holding the lower electrode 208 between the first and second lower insulating films 209 and 210 are obtained. At this point of time, the second insulating layer 218 is not yet provided with an opening for partially exposing each first wire 217.

Then, SiO₂ (silicon oxide) is deposited on the overall region of the semiconductor substrate 202 (including the second lower insulating films 210 and the second insulating layer 218) by P-CVD, and thereafter removed from the second insulating layer 218 by well-known photolithography and etching. Thus, a first sacrificial layer 252 made of SiO₂ is formed on the second lower insulating films 210 and portions of the semiconductor substrate 202 exposed through the spaces between the second lower insulating films 210 and the second insulating layer 218, as shown in FIG. 8C.

After the formation of the first sacrificial layer 252, SiN is deposited on the overall region of the semiconductor substrate 202 by P-CVD, and the deposition layer of SiN is patterned by well-known photolithography and etching. Thus, a third SiN layer 253 is formed, as shown in FIG. 8D. When the deposition layer of SiN is etched, the second insulating layer 218 is so partially etched that the opening 223 is formed in the second insulating layer 218 and the third SiN layer 253 to continuously pass through these layers 218 and 253 in the thickness direction.

Then, an Al film is formed on the overall region of the semiconductor substrate 202 by sputtering. Then, this Al film is patterned by well-known photolithography and etching. Thus, the upper electrodes 211, the second wire 220 and each pad 222 are formed on the third SiN layer 253, as shown in FIG. 8E.

Thereafter a fourth SiN layer is formed on the overall region of the semiconductor substrate 202 by P-CVD. Then, the pores 215, each opening 224 and grooves 254 corresponding to the clearances between the upper thin films 207 are formed in the fourth SiN layer by well-known photolithography and etching, as shown in FIG. 8F. Thus, the fourth SiN layer forms the four second upper insulating films 213 and the fourth insulating layer 221. The third SiN layer 253 is etched through the large number of pores 215 and the groves 254, whereby the large number of pores 214 and grooves continuous to the grooves 254 are formed in the third SiN layer 253, as shown in FIG. 5. Thus, the third SiN layer 253 forms the four first upper insulating films 212 and the third insulating layer 219, and the four upper thin films 207 are obtained in the structure formed by holding the upper electrodes 211 between the first and second upper insulating films 212 and 213.

Then, an etching solution (hydrofluoric acid, for example) is supplied from the pores 214 and 215, thereby etching the first sacrificial layer 252. Thus, a cavity is formed between the lower thin films 206 and the upper thin films 207, the upper thin films 207 are vibratory in the direction opposed to the lower thin films 206, and the semiconductor substrate 201 is obtained.

While the first lower insulating films 209, the second lower insulating films 210, the first upper insulating films 212, the second upper insulating films 213, the first insulating layer 216, the second insulating layer 218, the third insulating layer 219 and the fourth insulating layer 221 are made of SiN, the material therefor may be replaced with SiO₂ or a Low-k film material having a lower dielectric constant than SiO₂, so far as the same is an insulating material.

While the first sacrificial layer 252 is made of SiO₂, the material for the first sacrificial layer 252 is not restricted to SiO₂, but another material may be employed so far as the same has an etching selection ratio with the material for the first lower insulating films 209, the second lower insulating films 210, the first upper insulating films 212, the second upper insulating films 213, the first insulating layer 216, the second insulating layer 218, the third insulating layer 219 and the fourth insulating layer 221. If the first lower insulating films 209, the second lower insulating films 210, the first upper insulating film 212, the second upper insulating film 213, the first insulating layer 216, the second insulating layer 218, the third insulating layer 219 and the fourth insulating layer 221 are made of SiO₂, for example, SiN may be employed as the material for the first sacrificial layer 252.

Further, the material for the lower electrodes 208 and the upper electrode 211 is not restricted to Al, but another metal such as Au may be employed.

The four lower thin films 206 may be vibratorily provided at an interval from the surface of the semiconductor substrate 202.

In addition, various design changes can be applied in the range of the subject matter described in the scope of claims for patent.

While the present invention has been described in detail by way of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2007-269148 filed in the Japanese Patent Office on Oct. 16, 2007 and Japanese Patent Application No. 2007-270434 filed in the Japanese Patent Office on Oct. 17, 2007, the disclosures of which are incorporated herein by reference in its entirety.

What is claimed is:

1. A semiconductor device includes:
a semiconductor substrate; and
an MEMS sensor provided on the semiconductor substrate, wherein
the MEMS sensor comprises:
a vibratory first electrode; and
a plurality of second electrodes opposed to the first electrode at an interval.

2. The semiconductor device according to claim 1, further includes an acceleration detecting circuit detecting acceleration acting on the first electrode on the basis of a change in the capacitance of a capacitor formed by the first electrode and the second electrodes.

3. The semiconductor device according to claim 1, further includes a pressure detecting circuit detecting pressure input in the first electrode on the basis of a change in the capacitance of a capacitor formed by the first electrode and the second electrodes.

4. The semiconductor device according to claim 1, wherein
the second electrodes are individually covered with insulating films respectively, and
the insulating films are in contact with a surface of the semiconductor substrate.

5. The semiconductor device according to claim 1, further comprises a wire connected to the second electrodes, wherein
the wire is formed on the same layer as the second electrodes.

6. The semiconductor device according to claim 5, further comprises a pad for connecting the wire with an external device, wherein
the pad is formed on the same layer as the first electrode.

7. A semiconductor device includes:
a semiconductor substrate; and
an MEMS sensor provided on the semiconductor substrate, wherein
the MEMS sensor comprises:
a plurality of vibratory first electrodes; and
second electrodes of the same number as the first electrodes opposed to the first electrodes at an interval respectively.

8. The semiconductor device according to claim 7, further includes an acceleration detecting circuit detecting acceleration acting on the first electrodes on the basis of a change in the capacitance of each of capacitors formed by the first electrodes and the second electrodes.

9. The semiconductor device according to claim 7, further includes a pressure detecting circuit detecting pressure input in the first electrodes on the basis of a change in the capacitance of each of capacitors formed by the first electrodes and the second electrodes.

10. The semiconductor device according to claim 7, wherein
the second electrodes are individually covered with insulating films respectively, and
the insulating films are in contact with the surface of the semiconductor substrate.

11. The semiconductor device according to claim 7, further comprises a wire connected to the second electrodes, wherein
the wire is formed on the same layer as the second electrodes.

12. The semiconductor device according to claim 11, further comprises a pad for connecting the wire with an external device, wherein
the pad is formed on the same layer as the first electrodes.
